(19) United States
(12) Patent Application Publication
(10) Pub. No.: US 2006/0047633 A1
(43) Pub. Date: Mar. 2, 2006

(54) Cellular telephone directory service

(76) Inventors: Jay Fontana, Coral Springs, FL (US); Howard Weiser, Coral Springs, FL (US)

Correspondence Address: STEVENS DAVIS MILLER & MOSHER, LLP, 1615 L STREET, NW, SUITE 850, WASHINGTON, DC, 20036, US

(21) Appl. No.: 10/926,055

(22) Filed: Aug. 26, 2004

(51) Int. Cl. G06F 17/30

(52) U.S. Cl. 707/3

(57) ABSTRACT

Users of telecommunications systems, such as cellular or mobile telephones, pagers and facsimile machines can subscribe to a service which lists their information in a “white pages” or “yellow pages” format. The database can also be searched by users to find the information without browsing through the predetermined formats.

### BACKGROUND OF THE INVENTION

The present invention relates to a system for registering users on a cellular telephone directory. Through this system potential users can be contacted for their information and enabled or allowed to list their information in the database.

In conventional telephone directories, users are listed by their home phone numbers, and such listings are typically constrained to name, address and a single telephone listing, most often a “landline” number. These directories are generally published in large print volumes by the local telephone companies or a third party, and most often contain telephone listings for most of the telephone subscribers, residences or businesses in a particular area.

More recently, however, these conventional directories have developed into online searchable databases, allowing a user, anywhere throughout the world to conduct a search for an address and/or a landline telephone number.

### SUMMARY OF THE INVENTION

This invention develops and maintains an online directory to enable cellular phone users to find cellular phone numbers and email addresses of family and friends as well as website links to business services simply and quickly at little or no charge to a searcher. The system is dedicated to providing a simple and convenient solution that accommodates a growing need to more than 165 million cellular phone users to locate cellular telephone numbers and email addresses via this user friendly website directory.

In order to develop the database, an offer is transmitted to a large number of potential users. Therein, the potential users are asked to visit an Internet website to see how the database works, and to subscribe. In one embodiment, a teaser, e.g., a free temporary subscription, can be given to the general public, or to specific pre-selected users, as an incentive to try the service. Upon expiration of the temporary subscription, the user can be contacted to renew the subscription. In another embodiment, the for-pay subscription can begin automatically upon expiration of the teaser period.

### DETAILED DESCRIPTION

Via the system of this invention, visitors to a website will be given the ability to access a directory listing or initiate a search of the database based on various parameters, such as name, address (street, city and/or state), alone or in combination.

In a preferred embodiment, the database is populated by subscribing users. For example, in order to subscribe to the service, a potential user may be required to give information to be placed in the database. This information may include various parameters, including name, physical address, electronic mail address, static IP address, personal Internet web page, personal and/or business land-line telephone numbers, cellular or mobile telephone numbers, pager numbers, fax numbers and any other desired information, for example, business name and business type. As used throughout the specification and claims, the terms “cellular telephone” and “mobile telephone” are used interchangeably to refer to any two-way voice and/or data system accessible by inputting a pre-assigned number or address.

Alternatively, the database may be populated by information obtained through other sources. For example, home and/or business numbers may be obtained from telemarketing databases and input into the database. From there, the persons listed therein are preferably given the option to, possibly for a fee, supplement, correct or, optionally, remove information from the database.

In a preferred embodiment, the database may be presented in a “white pages” format, wherein the listings are displayed in order by name, possibly sorted by area code, zip code, or other address information. However, the presentation may also be sorted in a “yellow pages” format, wherein the listings are sorted by some other information, such as business-type or other keywords a user may input. For example, the database may include fields, such as association memberships, college and/or high schools attended, or any other personal information.

Preferably, cellular phone owners can pay a yearly charge to subscribe and have their cellular telephone number listed in the “white page” directory, the “yellow page” directory or both. Display and/or banner ads may also be purchased for a monthly or annual fee. Although searching the database may be done for free through the website, the database may also be searched by telephone, either by interacting with an automated system or by talking with a human operator, via, for example, a 900 telephone number. It is contemplated that searching through the website will be free, and other types of searches may be for a fee, however, it is certainly within the scope of the invention to charge a fee or provide either of these services for free. Additionally, searchers can be given the opportunity to pre-pay for a number of searches, or for unlimited searches for a period of time.

Registration and subscription collections may be completed on-line through a web site, and payment may be collected on the same website through a credit card or any other electronic funds transfer. Although users may be given the opportunity to mail a personal check or other payment devices to the operators of the website and/or database, such a payment method is time consuming and will delay processing of the new registration information.

The initial registrations may be for any selected time period, for example, one year, five years, six months, one month, as desired by the operators. In one embodiment, the user is given the ability to select the particular registration term from a variety of presented terms, possibly giving discounts for a long term, while in another embodiment, only a single term is possible. Subscriptions will, most preferably, contain an authorization to renew the subscription at the end of the initial term, unless the operators are notified in advance.

In an alternative embodiment, cellular phone users may be contacted to receive complimentary temporary subscriptions as a teaser. These listings may require a payment method, such as a credit card, only for verification purposes. Upon expiration of the teaser period, the listings may be automatically cancelled, or may be automatically billed to the payment method given to verify the user. Typically, the initial agreement presented to the user will indicate the events which automatically occur upon expiration of the teaser period.

In one embodiment, the cellular phone users can be given the teaser subscriptions when they sign up for cellular service or purchase phones or accessories. Alternatively, offers for the teasers may be electronically mailed to potential subscribers, without knowing in advance, if the electronic mail user has or uses a cellular phone. In another preferred embodiment, the teaser takes the form of a gift, such that the gift is mailed or given as an incentive to subscribe.

When a payment, such as a credit card or personal check, is declined, the database may contain a flag, optionally displayable to users of the directory. Such a flag would be a deterrent to users not to have their payment declined, as the database indicate that such user's listings have been associated with a “non-payment” are subject to immediate deletion from the database. Additionally, the system may be set-up that when such a “declined” flag is set, an automatic message, such as by electronic mail, a page, or an automated message to the user's cellular telephone reminds the user of the delinquent payment and possible termination of the listing in the database. These automatic messages may be repeated periodically until the delinquency has been rectified or the listing is terminated.

Although the present invention has been described in terms of specific embodiments, it will be apparent to one skilled in the art that various modifications may be made according to those embodiments without departing from the scope of the applied claims and their equivalents. Accordingly, the present invention should not be construed to be limited to the specific embodiments disclosed herein.

We claim:

1. A method of providing a searchable database comprising:
contacting a plurality of persons to inform said persons of the searchable database;
obtaining data about said persons to be listed in said database, said obtaining comprising at least one of obtaining said data directly from said persons, collecting said data from other databases, and allowing said persons to provide said data;
storing said data in a searchable database;
permitting searchers to search said database; and
displaying at least a portion of said database to said user.

2. The method of claim 1, wherein said contacting obtaining step comprises collecting a listing fee for inclusion in said database.

3. The method of claim 2, wherein said listing fee is for a period of time, and said method further comprising removing said data pertaining to one of said persons upon expiration of said period of time.

4. The method of claim 1, wherein said obtaining step comprises purchasing said data.

5. The method of claim 1, wherein said obtaining step comprises at least one method selected from the group consisting of:
collecting data from information provided by said persons to one or more third-parties.

6. The method of claim 5, wherein said third-parties are selected from the group consisting of telecommunications providers, subscription services and public utilities.

7. The method of claim 1, wherein said storing step is for a period of time, and expiration of said period of time, removing said data from said database.

8. The method of claim 7, wherein said storing for a period of time is free, and further comprising allowing said person to extend said period of time for a fee.

9. The method of claim 8, wherein said allowing step comprises automatically informing said person to inform said person of the expiration of said period of time.

10. The method of claim 9, wherein said informing step comprising automatically billing said person for extending said period of time.

11. The method of claim 8, wherein said informing step comprises sending said person an automatic message via one or more method selected from the group consisting of land-line telephone, mail, electronic mail, pager, cellular telephone, and facsimile.

12. The method of claim 1, wherein said data comprises at least one selected from the group consisting of name, land-line telephone number, address, cellular telephone number, pager number, electronic mail address, static IP address, personal web page, facsimile number, business name, business type, business contact information, and other contact information, and personal information selected from the group consisting of organizational membership, hobbies, school(s) attended, and professional information.

10. The method of claim 9. wherein said permitting step comprises sorting said database by one or more of said data.

11. The method of claim 1, wherein said permitting step comprises collecting a fee from said user.

12. The method of claim 1, wherein each record of said database comprises a field indicating a non-payment status.

13. The method of claim 1, wherein said obtaining step comprises collecting a fee from said persons.

14. The method of claim 1, wherein said obtaining step comprises giving said persons a teaser.

15. The method of claim 1, wherein said permitting step comprises providing said data to said searchers via the internet.

16. The method of claim 1, wherein said permitting step comprises providing said data to said searchers via a telephone.

17. The method of claim 1, wherein said displaying step comprises identifying said records having a non-payment indicator in said field to said user.
